(19) United States
(12) Patent Application Publication
(10) Pub. No.: US 2026/0266991 A1
(43) Pub. Date: Sep. 10, 2026

(54) Low-Power Proximity Sensing System for Pets

(71) Applicant: Arthur Thomas Bradley, Williamsburg, VA (US)

(72) Inventor: Arthur Thomas Bradley, Williamsburg, VA (US)

(21) Appl. No.: 19/224,674

(22) Filed: May 30, 2025

Related U.S. Application Data
(60) Provisional application No. 63/767,287, filed on Mar. 5, 2025.

(51) Int. Cl. G01S 17/04; G01S 7/484; G01S 7/4861; G01S 17/88

(52) U.S. Cl. CPC G01S 17/04; G01S 7/484; G01S 7/4861; G01S 17/88

(57) ABSTRACT

The present invention is a proximity sensor system comprising one or more transmitter modules operating in tandem with one or more receiver modules. Each transmitter module emits pulsed energy in the form of light. Each receiver module detects the transmitted light, and based on the energy level received, determines if the transmitter and receiver modules are in proximity to one another. If they are determined to be in proximity to one another, the receiver module activates an alarm. Thanks to innovative circuit designs and ultra-low-power electronics, the modules are small enough to attach to, or be integrated into, pet collars. This enables the novel proximity-sensing system to be used as anti-aggression devices between two or more pets.

### CROSS-REFERENCE TO RELATED APPLICATIONS

This application claims the benefit of U.S. provisional patent application No. 63/767,287 filed on Mar. 5, 2025 and titled “Low-Power Proximity Sensing System for Pets,” the content of which is incorporated by reference in its entirety.

### BACKGROUND

### Field of the Invention

The present invention relates generally to proximity sensing using pulsed light, and in particular to an ultra-low power, battery-operated, light-based proximity sensing system embedded into pet collars.

### Scope of the Prior Art

Proximity sensing systems use various technologies to determine range, including capacitive sensing, eddy current generation, magnetic switch activation, radio frequency ranging, and light transmission. Due to cost and technical requirements, pet proximity detection systems rely almost exclusively on radio frequency (RF) transceivers to determine range. Pet proximity systems consist of a receiver integrated into an oversized pet collar attachment, and a transmitter integrated into a module that can be attached to a wall, or placed on a shelf, couch, bed, or other region that is to be designated as a keep-out area. While the receiver may be battery operated, the transmitter portion generally relies on alternating current (AC) outlet power due to the much higher power consumption requirements. Pet fences are a common example of pet proximity systems. In the case of a pet fence, the transmitter is typically indoors and connected to AC power. A long wire is attached to the transmitter and routed around the property to serve as the transmitter antenna. When the pet gets too close to the antenna, the receiver on the pet's collar detects the RF signal and issues a corrective physical vibration, sound, light, electrical stimulus, or some combination thereof.

Such systems should not be confused with manual remote-controlled pet correction systems. Manual correction systems consist of a receiver integrated into an oversized pet collar attachment, and a transmitter integrated into a remote control. In this case, correction is given manually by pressing buttons on the remote control and does not include any form of proximity detection and, therefore, are not considered prior art. Additionally, due to high power requirements of the receiving and correction circuits in both the pet proximity and remote-controlled pet correction systems, the pet collar attachments typically have a battery life of only a few weeks before requiring recharging.

### SUMMARY

The present disclosure satisfies the foregoing needs by providing, inter alia, an integrated pet proximity system for addressing each of the foregoing desirable traits.

The present invention consists of one or more transmitter modules operating in tandem with one or more receiver modules. Each transmitter module transmits pulsed energy in the form of light, whose spectrum may be in the infrared, ultraviolet, or visible frequency regions. Likewise, each receiver module receives the transmitted light and uses it to determine if the transmitter module and receiver module are within a predefined proximity range (aka proximity) of one another. If the receiver module determines that the transmitter module is within the predefined proximity range, it activates an alarm (aka warning, corrective action), which may be a visible indicator, audible indicator, vibration motor, electrical stimulus device, or some combination thereof. The predefined proximity range corresponds to a distance exceeding a threshold range. Once the alarm is activated, the receiver module may continue to activate the alarm until the transmitter and receiver modules move out of proximity, or it may be configured to activate for a predefined period of time, regardless of whether or not they move out of proximity. Likewise, it may activate continuously while the two modules are in proximity, and then remain on for a fixed period of time after they move out of proximity. The system could also function in reverse, activating the alarm only when the modules move outside a predefined proximity range. In this arrangement, the system is warning that the two modules have moved away from one another, rather than toward one another.

In the simplest embodiment, a single transmitter module could be used with a single receiver module. In this embodiment, when the receiver module and transmitter module come to within the predefined proximity range of one another, the receiver module's alarm activates. A single transmitter module could also be used with multiple receiver modules. In this embodiment, when the transmitter module comes to withing a predefined proximity range of any receiver module, that receiver module's alarm activates. However, the alarms on the receiver modules outside the predefined proximity range would typically not be activated. Likewise, a single receiver module could also be used with multiple transmitter modules. In this embodiment, when the receiver module comes within the predefined proximity range of any of the transmitter modules, the receiver module's alarm activates. In more complex arrangements, multiple transmitter modules and receiver modules may operate in the same workspace. In this case, transmitter modules could be universal, that is able to work with every receiver module, or they may be keyed to operate only with specific receiver modules. This would enable multiple independent non-interfering transmitter-receiver module networks to operate in the same workspace.

One embodiment is to embed the transmitter module and receiver module integrated into separate pet collars. They may be integrated into housings that attach to the collar, or they may be more tightly integrated with the collar, such as formed into the collar's molded rubber structure or sewn into the collar's fabric. When animals wearing the collars come to within a predefined proximity range of one another, the receiver module detects the transmitter module's pulses of light and activates an alarm (aka warning, corrective action). This particular embodiment is useful in deterring animals from fighting or harassing one another. Depending on the type of alarm issued, the aggressor animal could either wear the collar housing the transmitter module or receiver module. For example, if a vibration motor was used as an alarm, the aggressor animal would likely wear the receiver module equipped with the alarm since it could be used to directly deter the animal from acting aggressively. Likewise, if flashing lights or sounds were used as an alarm, the victim animal would likely wear the receiver module with the alarm since this could help to scare away the aggressor. These are just sample arrangements, however, and there are no limitations about which animal could wear which collar.

Another embodiment is to have one module integrated into a pet collar and the other module integrated into a device worn or carried by the pet's owner. In this embodiment, when the pet strays beyond a predetermined distance from the owner, the receiver module could be used to either deter the animal from moving further away (if worn by the pet) or warn the pet owner of the animal's departure (if worn or carried by the owner). For this embodiment, the receiver's pulse detection would simply be reversed to warn when the animal and owner had moved beyond a predetermined distance rather than when moving to within a predetermined distance of one another. Such an embodiment could be used for training or to help ensure the safety of the animal.

Yet another embodiment would be to integrate both the transmitter and receiver modules into the same pet collar or pet collar attachment. The second pet collar would not include any transmitting or receiving electronics but rather be equipped with a passive reflective surface capable of efficiently reflecting the pulses of light emitted from the transmitter module. The first collar would emit light pulses that, when in proximity, would reflect off the second collar to be received back at the first collar. Once again, this could act as a proximity detection system between two animals. When the animals came to within a minimum predetermined distance, the collar with the transmitter and receiver modules would activate the alarm in the receiver module. The same concept could be implemented between a pet and pet owner, with one of the two being equipped with the active transmitter-receiver module, and the other being equipped with a collar, band, or other accessory with a passive reflective surface that reflects the incident light pulses.

The transmitter and receiver modules in this disclosure both rely on ultra-low-power (aka nano-power, micro-power) analog and digital electronics, enabling them to be powered using very small batteries (e.g., coin cell batteries). Specifically, the transmitter module incorporates an ultra-low-power pulse generator, and the receiver module incorporates an ultra-low-power pulse detector that activates the alarm when a received pulse is detected. These innovations and others enable the transmitter and receiver modules to operate without the need for a microcontroller, sampling system, logical memory, software, firmware, or other programmable circuitry. This further helps to simplify the complexity of the systems, miniaturize the devices, and reduce the average power consumption.

The present invention offers numerous advantages over existing pet proximity detection systems. First, both the transmitter and receiver modules have such low average power consumption that they can be powered by small coin cell (aka button) batteries for durations exceeding 6 months, a year, or even multiple years, depending on the battery capacity. For example, when using a CR2032 3-volt coin cell battery with 225 mA-hour capacity, a product needs to have an average power consumption less than approximately 80 microwatts to achieve a full year of operation. Likewise, when using a CR1225 3-volt coin cell battery with 50 mA-hour capacity, a product would need to have an average power consumption less than approximately 20 microwatts to achieve a full year of operation. The present invention is able to achieve average power consumption rates that support the use of coin cell batteries for extended operating periods. (e.g., the transmitter module has an average power consumption that is preferably less than 100 microwatts, less than 80 microwatts, less than 60 microwatts, less than 40 microwatts, and most preferably less than 20 microwatts, the receiver module has an average power consumption that is preferably less than 100 microwatts, less than 80 microwatts, less than 60 microwatts, less than 40 microwatts, and most preferably less than 20 microwatts, the transmitter module and its corresponding receiver module each have an average power consumption that is preferably less than 100 microwatts, less than 80 microwatts, less than 60 microwatts, less than 40 microwatts, and most preferably less than 20 microwatts, or the transmitter module, in combination with its corresponding receiver module, have an average power consumption that is preferably less than 100 microwatts, less than 80 microwatts, less than 60 microwatts, less than 40 microwatts, and most preferably less than 20 microwatts). This eliminates or, at the very least, greatly mitigates the need for recharging. Second, the present invention uses unique transmitter and receiver circuits that are physically small enough to be integrated into even the smallest pet collars. This enables them to be used in combination between two or more animals (e.g., cats, dogs, farm animals, etc.), detecting when the equipped animals come into proximity to one another, and subsequently issuing an alarm to deter aggressive behavior.

Additionally, when integrating one of the modules into a pet's collar and the other into a device worn or carried by the pet's owner (e.g., handheld remote, bracelet, lanyard, watch band), the invention can be used to warn the owner when the pet has moved too far away. Alternatively, by integrating an alarm in the pet's collar, the same system could be used to deter the pet from moving too far away from its owner, something that might be especially useful during outdoor walking or conducting training exercises.

Finally, unlike existing pet proximity systems which rely on RF transmissions, the present invention uses light transmissions (e.g., infrared, ultraviolet, visible) for proximity detection. This greatly simplifies the detection, as well as eliminates potential issues of radio frequency interference, multipath effects, and regulatory requirements.

### BRIEF DESCRIPTION OF THE DRAWINGS

The invention is a pet proximity detection system that comprises a transmitter module configured to emit light pulses, a receiver module configured to detect the light pulses and determine whether the transmitter module is within or outside of a predefined proximity range, and an alarm module operatively coupled to the receiver module. The alarm module contains an alarm that activates when a determination is made that the transmitter module and receiver modules are within the predefined proximity range, that is having exceeded or have come to within the range threshold. The proximity of the transmitter module to the receiver module is determined based on a measurement of optical energy emitted by the transmitter module and received by the receiver module.

The foregoing summary, as well as the following detailed description of preferred variations of the invention, will be better understood when read in conjunction with the appended drawings. For the purpose of illustrating the invention, presently preferred variations are shown in the drawings. It should be understood, however, that the invention is not limited to the precise arrangements shown. In the drawings, where:

FIG. 1 illustrates prior art of a pet proximity system embodied as an invisible pet fence.

FIG. 2 illustrates prior art of a pet proximity system embodied as a restricted zone.

FIG. 3 illustrates a simplified block diagram of the present invention, according to an embodiment.

FIG. 4 illustrates a simplified block diagram of the transmitter module, according to an embodiment.

FIG. 5 illustrates a simplified schematic view of one embodiment of the transmitter module, according to an embodiment.

FIG. 6 illustrates a simplified block diagram of the receiver module, according to an embodiment.

FIG. 7 illustrates a simplified schematic view of the receiver's pulse detector element, according to an embodiment.

FIG. 8 illustrates a simplified schematic view of one embodiment of the receiver module, according to an embodiment.

FIG. 9 illustrates a simplified timing diagram for the receiver's pulse detector element, showing the conversion of a single received optical pulse to a longer-duration pulse used to signal or drive the alarm, according to an embodiment.

FIG. 10 illustrates a simplified timing diagram for the receiver's pulse detector element, showing the conversion of a string of received optical pulses to a longer-duration pulse used to signal or drive the alarm, according to an embodiment.

FIG. 11 illustrates the exploded view of one embodiment of the transmitter and receiver modules integrated into small housings, according to an embodiment.

FIG. 12 illustrates an embodiment of the present invention in which the transmitter module and receiver module are integrated into housings attached to two pet collars.

FIG. 13 illustrates an embodiment of the present invention in which the transmitter and receiver modules are integrated directly into pet collars with additional transmitting emitters and receiving sensors along the collars.

FIG. 14 illustrates an embodiment of the present invention in which the receiver module and transmitter module are integrated into the collars of two pets.

FIG. 15 illustrates an embodiment of the present invention in which the receiver module is integrated into a pet collar, and the transmitter module is integrated into a device worn on the pet owner's wrist.

FIG. 16 illustrates an embodiment of the present invention in which the receiver module and transmitter module are integrated into a common housing on a pet collar. The embodiment utilizes a passive reflective surface integrated into a collar worn by the second pet.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of pet proximity detection, it will be recognized by those of ordinary skill that the present disclosure is not so limited. In fact, the principles of the present disclosure described herein may be readily applied to other proximity applications, including, but not limited to, those used for security systems, material tracking, industrial automation, medical equipment keep-out zones, robotics, and home automation. As such, the same or similar circuitry could be used in other devices besides pet collars for purposes of proximity sensing and monitoring.

In the present specification, an implementation showing a singular device should not be considered limiting; rather, the disclosure is intended to encompass other implementations including a plurality of the same device, and vice-versa, unless explicitly stated otherwise herein. Further, the present disclosure encompasses present and future known equivalents to the devices referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

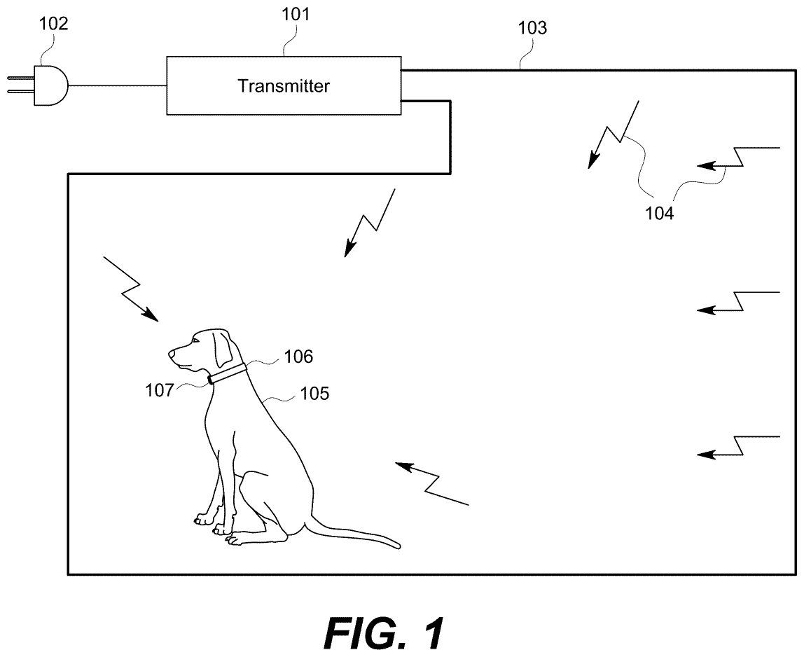

FIG. 1 illustrates prior art of a pet proximity system embodied as an underground pet fence. In this system, the transmitter 101 drives pulsed electrical signals out to a buried antenna 103 enclosing the animal containment area (aka pen). The antenna 103 emits radio frequency (RF) signals 104 which are received by the receiving device 107 mounted to the collar 106 worn by the enclosed pet 105. Due to power requirements, the transmitter 101 requires connection to utility power using direct wiring or a conventional outlet plug 102. When the pet 105 comes in proximity to the buried antenna 103, the receiving device 107 issues an electrical stimulus (aka electrical shock) or other correction to the neck of the pet 105, with the intent of coercing the pet 105 to retreat further back into the pen or otherwise deter them from escaping the pen.

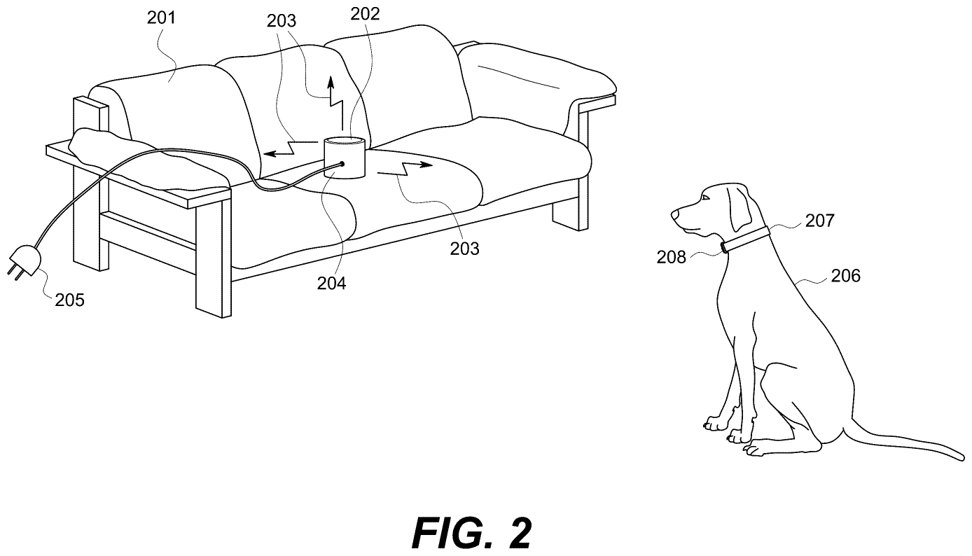

FIG. 2 illustrates another prior art example of a pet proximity system, this one embodied as a restricted zone. In this system, the transmitter 204 has an integrated antenna 202 that emits radio frequency (RF) signals 203 which are received by the receiving device 208 mounted to the collar 207 of the pet 206. Due to power requirements, the transmitter 204 requires connection to utility power using a conventional outlet plug 205. When the pet 206 comes in proximity to the transmitter 204, placed on a couch 201 in this example, the receiving device 208 mounted on the pet's collar 207 issues a shock or other electrical stimulus to the neck of the pet 206, with the intent of coercing the pet to retreat away from the transmitter. This arrangement effectively sets up a keep-out zone in which the pet 206 is taught to stay out of a predetermined area through negative reinforcement.

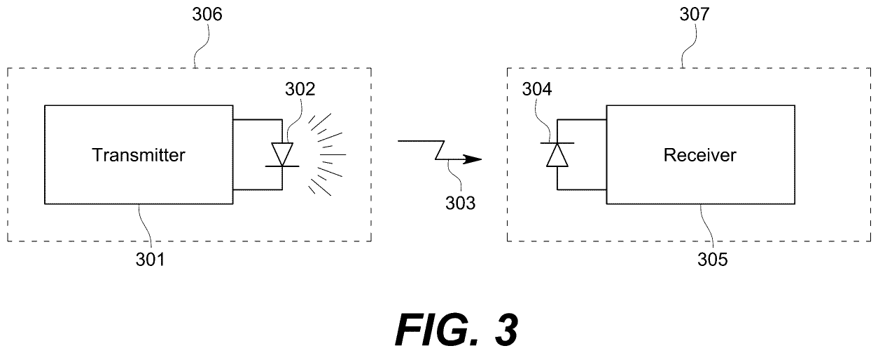

FIG. 3 illustrates a simplified block diagram of the present invention. The proximity detection system consists of a transmitter module 306 and a receiver module 307. The transmitter module 306 includes a transmitter 301 and an optical emitter 302, and the receiver module 307 consists of a receiver 305 and a photodetector 304. The optical emitter 302 transmits pulsed light 303 to the photodetector 304 for purposes of proximity monitoring. The energy in the pulsed light 303 received by the photodetector 304 is used as an indicator of the proximity of the two modules 306 307. The characteristics of the light pulses 303 can vary for different applications and environments. The transmitter module 306 is configured to emit at least a first-type light pulse having a first characteristic and a second-type light pulse having a second characteristic. The receiver module 307 is configured to detect and distinguish between the first-type light pulse and the second-type light pulse. The first characteristic and the second characteristic correspond to different optical wavelengths (e.g., infrared, ultraviolet, visible), pulse widths, pulse repetition rates, duty cycles, or energy levels. According to an embodiment, the one or more optical emitters 302 can include light-emitting diodes (LEDs), lasers, incandescent bulbs, or any combination thereof. According to an embodiment, the one or more optical emitters can include light-emitting diodes (LEDs), lasers, incandescent bulbs, or any combination thereof.

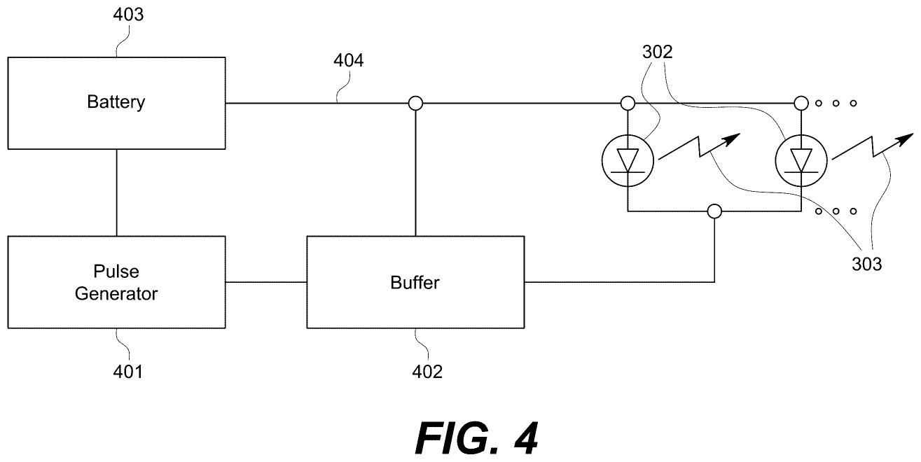

FIG. 4 illustrates a simplified block diagram of the transmitter module 306. The transmitter module 306 comprises a pulse generator 401 configured to generate electrical pulses and an optical emitter 302 configured to emit the light pulses 303 in response to the electrical pulses. The pulse generator 401 generates electrical pulses, which may be voltage or current. The characteristics of the pulses can vary for different applications and environments. Such characteristics might include, but are not limited to, pulse rate, pulse width, duty cycle, and amplitude. The electrical pulses are passed to the buffer 402 which more effectively drives the optical emitters 302. The buffer 402 may also provide hysteresis. The hysteresis helps to prevent erroneous pulsing due to system electrical noise, electromagnetic interference, or slow pulse signal level transitions. The buffer 402 drives the electrical pulses to the optical emitters 302, which when switched on, emit light. The transmitter module 306 may have any number of optical emitters 302, based on the particular application. The optical emitters 302 emit pulses of light 303. The size, packaging, field-of-view, wavelength, intensity, and other characteristics of the optical emitters 302 may vary based on application. A battery module 403 provides electrical power via a connection 404 to the pulse generator 401, buffer 402, and optical emitters 302. The battery module 403 may be rechargeable or non-rechargeable. According to an embodiment, the one or more battery modules can include rechargeable batteries, non-rechargeable batteries, supercapacitors or any combination thereof.

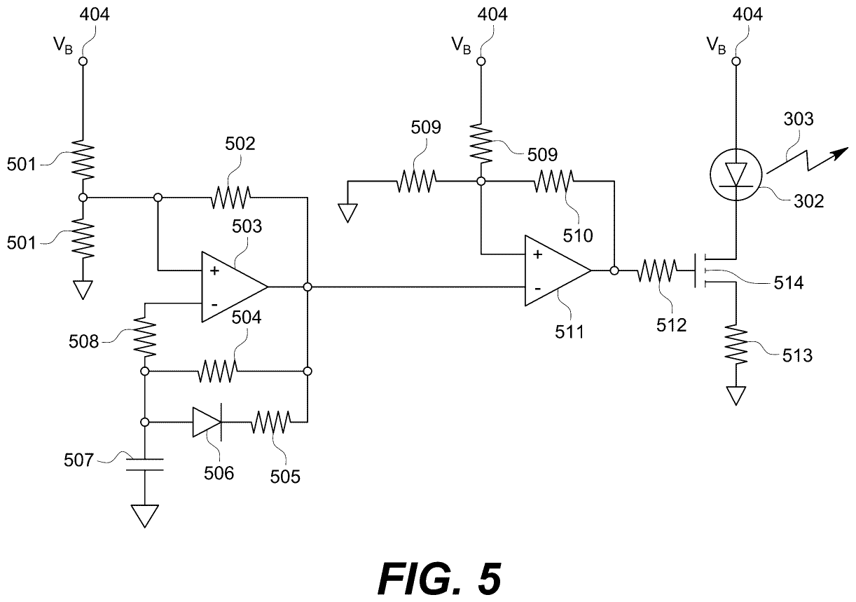

FIG. 5 illustrates a simplified schematic view of the transmitter module 306, excluding the battery module 403, which is not shown. In this embodiment, the pulse generator 401 is a comparator circuit that comprises voltage divider resistors 501, positive feedback resistor 502, comparator amplifier 503, negative feedback resistor 504, negative terminal resistor 508, discharge diode 506, discharge resistor 505, and capacitor 507. The comparator amplifier 503 initially starts with its output at or near the power supply low-voltage rail (e.g., ground). The voltage created on the non-inverting terminal due to battery voltage 404 and the voltage divider resistors 501 quickly drive the comparator amplifier's 503 output to, or near to, the power supply high-voltage rail (e.g., battery voltage 404). The output of the comparator amplifier 503 feeds through the negative feedback resistor 504 to charge the capacitor 507. When the voltage on the inverting terminal of the comparator amplifier 503 exceeds that on the non-inverting terminal, the comparator amplifier's 503 output drives to the power supply's low-voltage rail. The capacitor 507 then begins to discharge through a parallel combination of the negative feedback resistor 504 and the discharge resistor 505 in series with the discharge diode 506. When the voltage on the comparator amplifier's 503 inverting terminal falls below the voltage on the non-inverting terminal, the comparator amplifier's 503 output drives back to the power supply high-voltage rail again. This cycle repeats indefinitely, creating a pulse train whose pulse width, repetition rate, and duty cycle are set by the bias, feedback components, and comparator, as described. By setting the negative feedback resistor 504 to be a much higher value than the discharge resistor 505, the capacitor 507 charge time can be set much longer than the discharge time. In the embodiment shown, this is used to create a low duty cycle pulse train of negative-going pulses. Reversing the direction of the discharge diode 506 results in a train of positive-going pulses. The buffer 402 comprises buffer divider resistors 509, buffer feedback resistor 510, buffer comparator 511, and series resistor 512. Together, these components act as a rail-to-rail inverting amplifier with hysteresis. The output of the comparator amplifier 503 feeds into the inverting terminal of the buffer comparator 511. The buffer feedback resistor 510 and buffer divider resistors 509 establish the hysteresis low and high switching levels for the buffer 402. In this embodiment, the output of the buffer comparator 511 feeds a series resistor 512, which is used to isolate the buffer comparator 511 from the internal capacitance of a field effect transistor 514. The transistor is used to enable current to flow through the optical emitter 302 and may or may not be required, depending on whether the current required by the optical emitter 302 exceeds the drive capability of the buffer comparator 511. In this embodiment, a positive voltage applied to the gate of the field-effect transistor 514 will turn on the device and allow current to flow through the optical emitter 302, causing it to emit light 303. The bias current through the optical emitter 302 is set by the current limiting resistor 513, the output voltage of the buffer comparator 511, and the turn-on characteristics of the field-effect transistor 514 and optical emitter 302. The energy of the emitted light 303 is directly related to the bias current through the optical emitter 302. The transmitter module 306 is powered by a battery voltage 404 provided by the battery module 403, not shown.

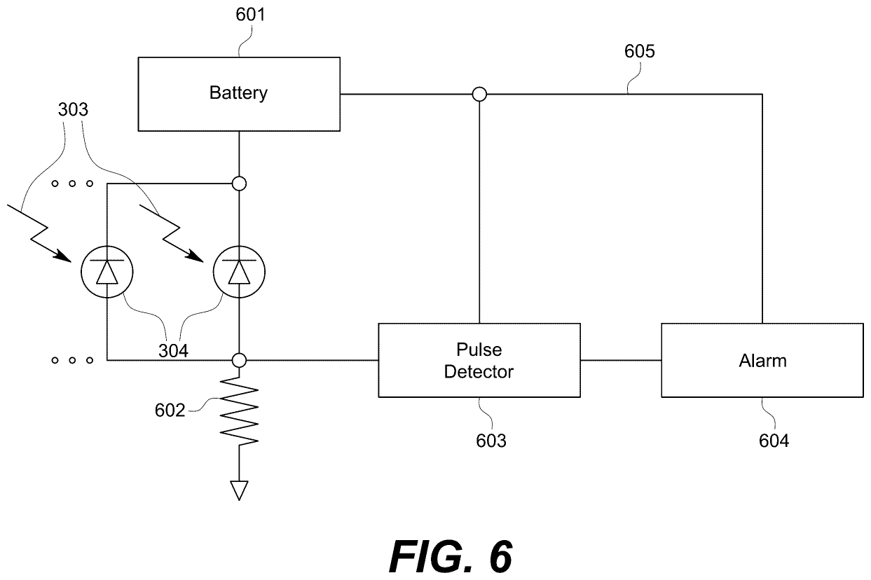

FIG. 6 illustrates a simplified block diagram of the receiver module 307. The receiver module 307 comprises a photodetector 304 configured to detect the light pulses 303 and a pulse detector 603 configured to process signals from the photodetector 304 for purposes of determining proximity between the transmitter module 306 and the receiver module 307. The photodetectors 304 receive incoming pulses of light 303. The receiver module's photodetectors 304 are matched to efficiently receive light emitted from the transmitter module's 306 optical emitters 302. The bias resistor 602 and battery module's 601 voltage level are used to set the voltage or current levels passed to the pulse detector 603. The pulse detector 603 detects when an incoming pulse is present, indicating when the transmitter and receiver modules 306 307 have come to within a predefined proximity range, and outputs a control signal to the alarm module 604. The predefined proximity range corresponds to the separation distance between the transmitter module 306 and receiver module 307 crossing a threshold range, such that the alarm module is configured to activate the alarm when the transmitter module is detected to be either farther than the threshold range from the receiver module 307, or when the transmitter module 306 is detected to be closer to the receiver module 307 than the threshold range. According to an embodiment, the one or more optical emitters can include light-emitting diodes (LEDs), lasers, incandescent bulbs, or any combination thereof. According to an embodiment, the one or more battery modules can include rechargeable batteries, non-rechargeable batteries, supercapacitors or any combination thereof.

Although not shown, the pulse detector 603 may also include a buffer similar to the buffer 402 in the transmitter module 306. When driven electrically by the pulse detector 603, the alarm module 604 activates an alarm. The alarm indicates when pulses are detected by the pulse detector 603 and may remain on for a fixed amount of time after pulses are no longer received. This helps to prevent the alarm module 604 from toggling on and off when there are minor unexpected gaps between pulses. The alarm module 604 comprises one or more alarms that may include visible indicators, audible indicators, vibration motors, electrical stimulus devices, or any combination thereof. The receiver module 307 may have any number of photodetectors 304, based on the application. The photodetectors 304 detect pulses of light 303. The size, packaging, field-of-view, wavelength, and other characteristics of the photodetectors 304 may vary based on application. A battery module 601 provides electrical power to the photodetectors 304, pulse detector 603, bias resistor 602, and alarm module 604. The battery module 601 may be rechargeable or non-rechargeable.

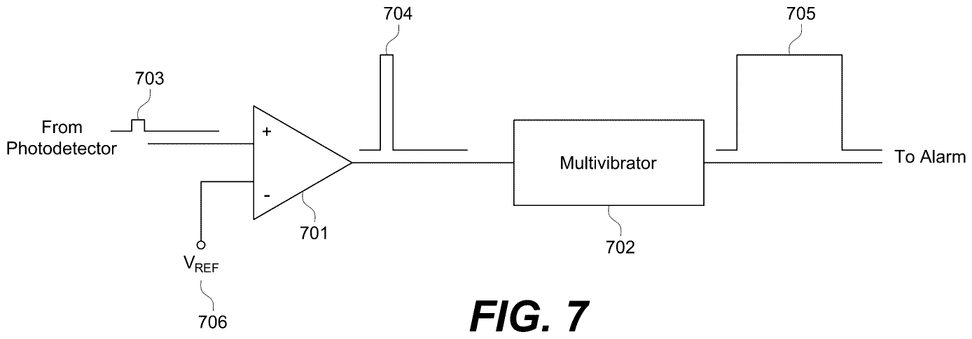

FIG. 7 illustrates a simplified schematic view of one embodiment of the receiver module's 307 pulse detector 603. The light pulses 303 transmitted from the transmitter module 306 is received by the receiver module's photodetectors 304 and converted to an electrical signal 703 in the form of a voltage or current. When that photodetector's 304 electrical signal 703 exceeds a predetermined reference voltage VREF 706, the output of the comparator 701 goes high. The photodetector's 304 electrical signal 703 is designed to exceed the reference voltage VREF 706 when the transmitter and receiver modules 306 307 come to within a predefined proximity range. The comparator's output 704 is then passed to a multivibrator circuit (i.e., monostable or astable) 702, which initiates the creation of a pulse 705 with a controlled-duration pulse width. This pulse 705 drives the alarm module 604, activating the alarm for a time set by the multivibrator circuit 702.

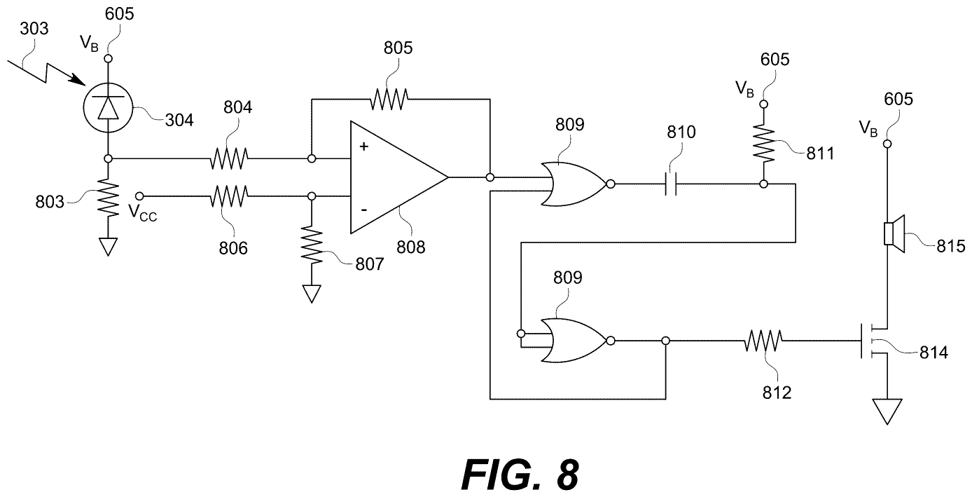

FIG. 8 illustrates a simplified schematic view of one embodiment of the receiver module 307, excluding the battery module 601, which is not shown. Pulsed light 303 is received by the photodetector 304, shown as a photodiode in this embodiment. In turn, the photodetector 304 drives pulses of current through the bias resistor 803 and 804 and feedback resistor 805. This results in a voltage applied to the non-inverting terminal of the op amp 808. When the voltage at the anode of the photodiode 304 exceeds the comparator circuit's low hysteresis voltage, the output of comparator 808 goes high. Once high, the input, again defined as the voltage on the anode of the photodiode 304, must fall below the hysteresis low voltage for the output of the comparator 808 to drop low. The difference between the hysteresis high and low voltages is given by the supply voltage times the ratio of the input resistor 804 divided by the feedback resistor 805. The output of the comparator 808 drives the input of a multivibrator circuit 702, shown in this embodiment as two cross-coupled NOR gates 809 and a resistor 811 and feedback capacitor 810. The pulse width of the multivibrator's output is set by the resistor 811 and capacitor 810, and to a lesser degree, the characteristics of the NOR gates 809. The output of the multivibrator drives the gate of a field-effect transistor 814 through a series resistor 812. The purpose of the series resistor 812 is to isolate the NOR gate's 809 output from the internal capacitance of the field-effect transistor 814. The series resistor 812 may be excluded if the NOR gate 809 has the capability to drive the field-effect transistor's internal capacitance. In this embodiment, a field-effect transistor is used to switch power to the alarm 814, but in many embodiments, the NOR gates 809 might drive the alarm directly without the inclusion of a field-effect transistor 814. Also, other switching devices could be used instead of the field-effect transistor, such as a relay or bipolar transistor. In this embodiment, a high voltage applied to the gate of the field-effect transistor 814 will turn on the field-effect transistor 814 and allow current to flow to the alarm 815, activating it. The comparator's 808 output will remain at the low voltage until pulses are no longer received by the photodetector 304. When pulses are no longer received, the multivibrator circuit's capacitor 810 will begin to discharge through the discharge resistor 810 and NOR gates 809 until the output of the multivibrator circuit 702 drops low, turning off the field-effect transistor 814 and alarm 815. The receiver module 307 is powered by a battery voltage 605 provided by the battery module 601, not shown.

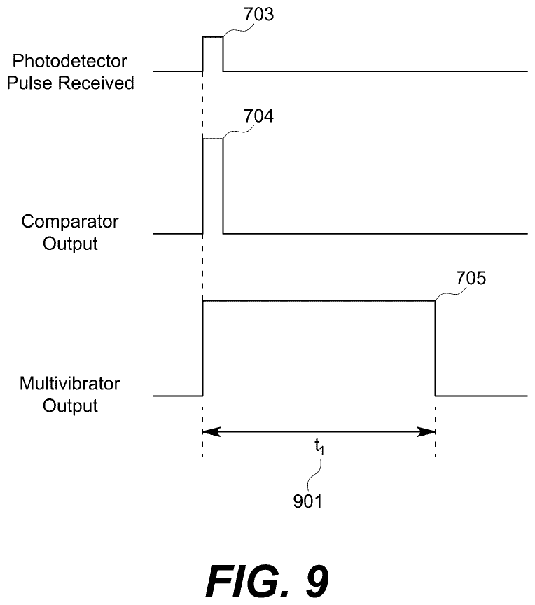

FIG. 9 illustrates the timing diagram for the receiver module 307 when a single pulse 703 is received by the photodetector 304. The electrical pulse 703 represents the electrical pulse resulting from an optical pulse received by the photodetector 304. The electrical pulse 703 causes the comparator 808 to output a pulse 704 with an amplitude determined by its low supply to high supply values, and whose width is primarily set by the hysteresis of the comparator 808 circuit. The comparator's 808 output drives the multivibrator circuit 702, which outputs a pulse 705 with a pulse width of t1 901. The controlled-duration pulse 705 from the multivibrator circuit 702 activates the alarm module 604, turning it on for a fixed time set by t1 901.

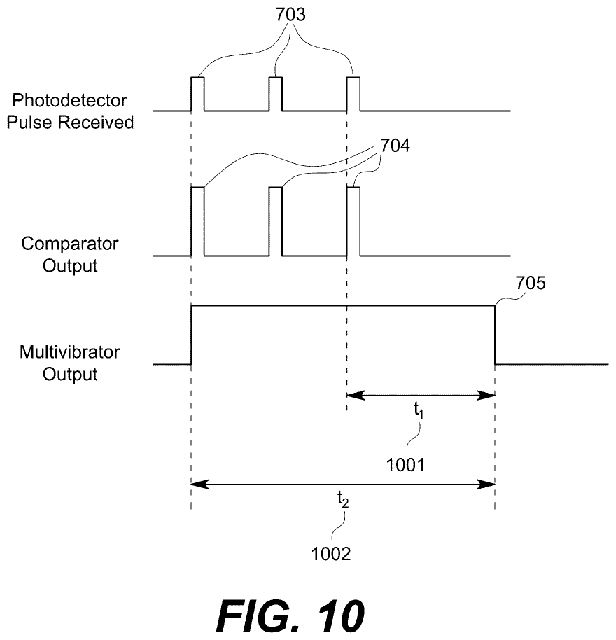

FIG. 10 illustrates the timing diagram for the receiver module 307 when multiple pulses 703 are received by the photodetector 304. The pulses 703 represent the electrical pulses resulting from multiple optical pulses received by the photodetector 304. The electrical pulses 703 cause the comparator 808 to output corresponding pulses 704 with an amplitude that is determined by its low supply to high supply values, and whose width is primarily set by the hysteresis of the comparator 808 circuit. The comparator's 808 output drives the multivibrator circuit 702, which outputs a pulse 705 with a pulse width of t2 1002. The controlled-duration pulse 1002 from the multivibrator circuit 702 activates the alarm module 604, turning it on for a fixed time set by t2 1002. Note that in this particular embodiment, the controlled-duration pulse 1002 continues for a fixed time t1 1001 after the final 704 pulse is received. However, the pulse 705 does not necessarily have to continue past the final pulse 703 received from the photodetector 304.

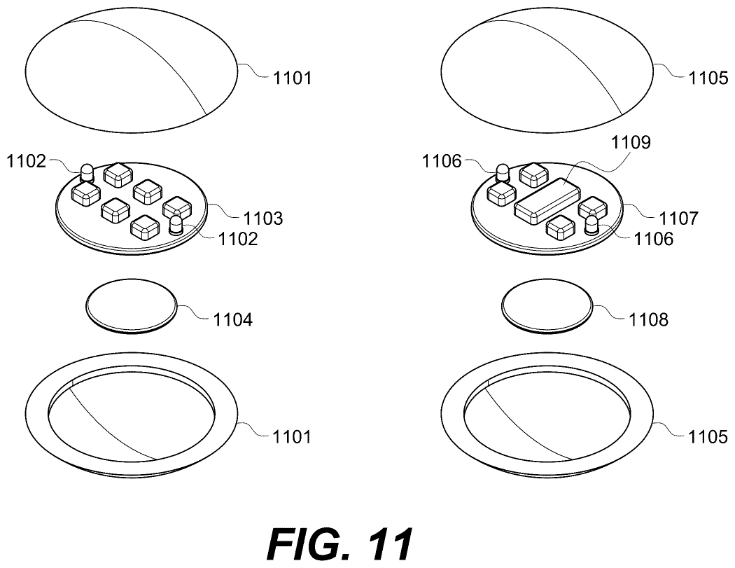

FIG. 11 illustrates the exploded view of one embodiment of the transmitter module 306 and receiver module 307 integrated into small housings 1101 1105 that attach to pet collars. The transmitter housing 1101 encloses the transmitter 301. One or more optical emitters 1102 may also be contained in or on the transmitter housing 1101. In this simple embodiment, two optical emitters 1102 are integrated on the transmitter's 301 circuit board 1103. Additionally, or alternatively, optical emitters 1102 may be integrated elsewhere in or on the collar, for example on the periphery or surface of the collar. In this embodiment, the transmitter's 301 circuit board 1103 also contains the battery module 1104. In other embodiments, the battery module 1104 may be integrated elsewhere in or on the collar. The receiver housing 1105 encloses the receiver 305. One or more photodetectors 1106 may be contained in the receiver housing 1105. In this simple embodiment, two photodetectors 1106 are integrated on the receiver's 305 circuit board 1107. Additionally, or alternatively, photodetectors 1106 may be integrated elsewhere in or on the collar, for example on the periphery or surface of the collar. In the embodiment shown, the receiver's 305 circuit board 1107 also contains the battery module 1108 and alarm 1109. In other embodiments, the battery module 1108 and alarm 1109 may be integrated elsewhere in or on the collar. In this embodiment, at least one of the transmitter module 306 and the receiver module 307 is attached to, or integrated into, a pet collar or a wearable accessory, such as a remote control, wristband, necklace, watch, belt, ring, and pendant.

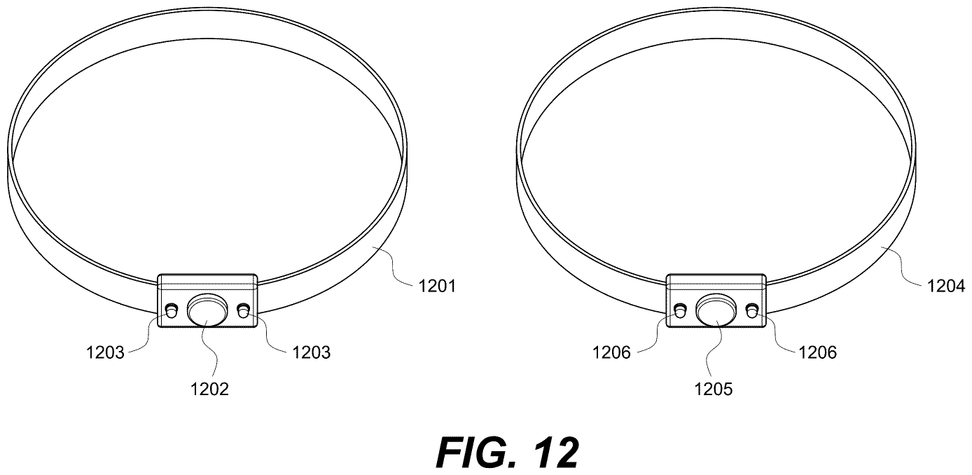

FIG. 12 illustrates an embodiment of the present invention in which the transmitter module 306 is integrated into a transmitter housing 1202 attached to a pet collar 1201, and the receiver module 307 is integrated into a receiver housing 1205 attached to a second pet collar 1204. In this simple embodiment, two optical emitters 1203 are integrated into the transmitter housing 1202. Likewise, two photodetectors 1206 are integrated into the receiver housing 1205. In other embodiments, additional optical emitters 1203 and photodetectors 1206 could be integrated elsewhere on the collars 1201 1204 or in the transmitter or receiver housings 1202 1205.

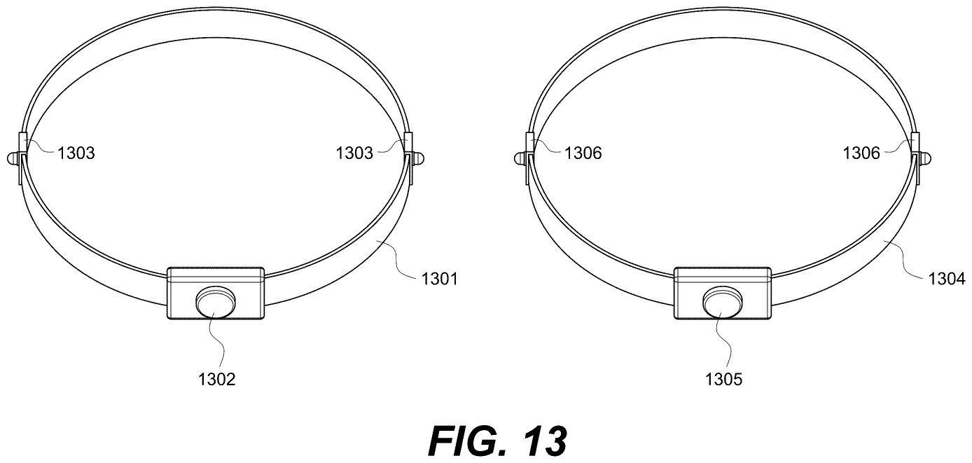

FIG. 13 illustrates an embodiment of the present invention in which the transmitter module 306 is integrated into a transmitter housing 1302 attached to a pet collar 1301, and the receiver module 307 is integrated into a receiver housing 1305 attached to a second pet collar. In this embodiment, two optical emitters 1303 are integrated one to each side of the transmitter collar 1301. Likewise, two photodetectors 1306 are integrated one to each side of the receiver collar 1304. In other embodiments, optical emitters 1303 and photodetectors 1306 could be integrated elsewhere on the collars 1301 1304 or in the transmitter or receiver housings 1302 1305. Additionally, optical emitters 1303 and photodetectors 1306 could be made as part of collar's structure (e.g., formed into the rubber mold, sewn into the fabric, riveted onto the collar, etc.).

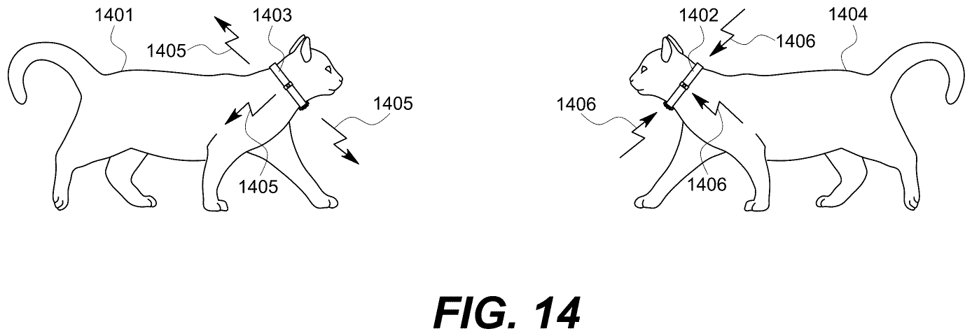

FIG. 14 illustrates an embodiment of the present invention in which the transmitter module 306 is integrated into a pet collar 1403, and a receiver module 307 is integrated into a second pet collar 1402. The transmitter module 306 emits pulses of light 1405, and the receiver module 307 receives that light 1406. The combined system is designed to detect when the two animals 1401 1404 come within proximity to one another. When they are within proximity to one another, the alarm module 604 contained in receiver module 307 integrated into the pet collar 1402 activates.

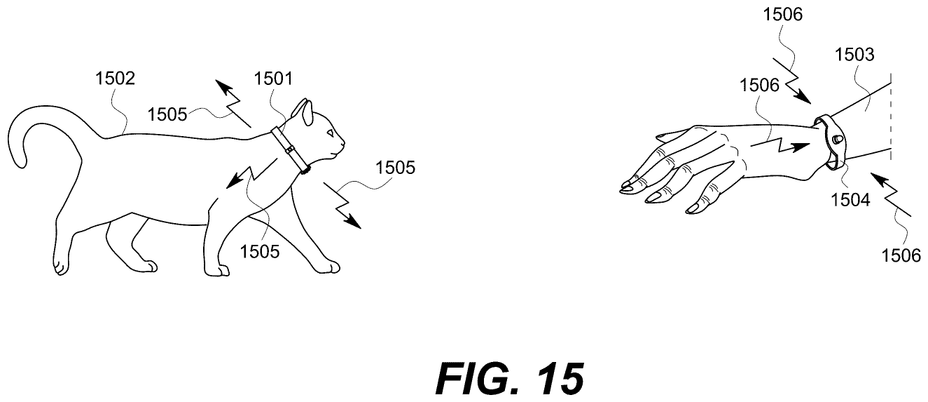

FIG. 15 illustrates an embodiment of the present invention in which the transmitter module 306 is integrated into a pet collar 1501, and the receiver module 307 is integrated into a device 1504 worn on the pet owner's wrist 1503. The system is designed to detect when the pet 1502 and owner 1503 move out of proximity to one another. Once they move out of proximity, the alarm module 605, contained in receiver module 307, activates. Alternatively, the alarm module 604 could be configured to activate when the owner 1503 and pet 1502 move within proximity to one another, rather than when they move away from one another. The current embodiment shown has the receiver module 307 being worn on the owner's wrist 1503 and the transmitter module 306 being worn by the pet 1502. An alternative embodiment that allowed the pet to experience the alarm would have the owner wearing the transmitter module 306, with the pet wearing the receiver module 307. In this embodiment, at least one of the transmitter module 306 and the receiver module 307 is attached to, or integrated into, a pet collar or a wearable accessory, such as a remote control, wristband 1504, necklace, watch, belt, ring, and pendant.

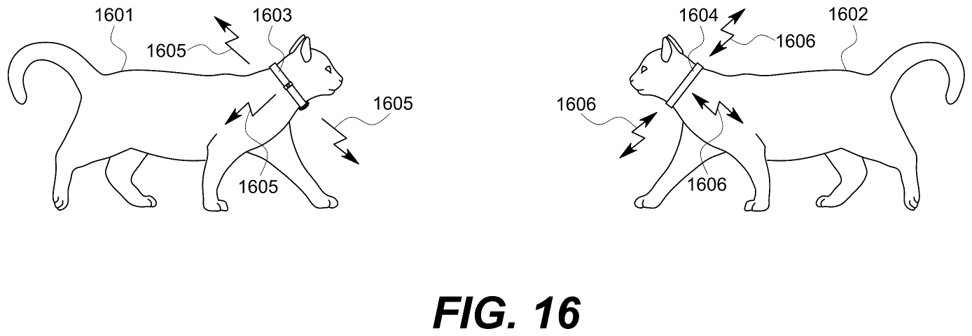

FIG. 16 illustrates an embodiment of the present invention in which the receiver module 307 and transmitter module 306 are both integrated into a common housing integrated into a pet collar 1603 worn by the first pet 1601. A simple reflective collar 1604 with a passive reflective surface is worn by the second pet 1602. When the pets 1601 and 1602 come within proximity to one another, the transmitter module's 306 optical emitters 302 emit light 1605 that reflects off the second collar's 1604 passive reflective surface 1606 to be received back at the receiver module's 307 photodetectors 304 in the first collar 1603. The reflected light 1604 then activates the alarm module 604 in the receiver module 307 on the pet collar 1603. The same principle may be applied for reflecting off any external object, not just a collar.

The embedded pet proximity detection system of this disclosure embodies a significant advancement over proximity systems. The present invention's small size, simple analog circuit design, and minimal power consumption enables battery-operated proximity detection between two pets, a capability that is not available in existing pet proximity systems. Additionally, it can be used to monitor the proximity of a pet to its owner, enabling more effective training methods.

I claim:

1. A pet proximity detection system comprising:
a transmitter module configured to emit light pulses;
a receiver module configured to detect the light pulses and determine whether the transmitter module is within a predefined proximity range; and
an alarm module operatively coupled to the receiver module and configured to activate an alarm in response to a determination that the transmitter module is within the predefined proximity range.

2. The system of claim 1, wherein
the transmitter module comprises a pulse generator configured to generate electrical pulses and an optical emitter configured to emit the light pulses in response to the electrical pulses; and
the receiver module comprises a photodetector configured to detect the light pulses and a pulse detector configured to process signals from the photodetector to determine a proximity between the transmitter module and the receiver module.

3. The system of claim 1, wherein
the predefined proximity range corresponds to a distance exceeding a threshold range, such that the alarm module is configured to activate the alarm when the transmitter module is detected to be farther from the receiver module than the threshold range.

4. The system of claim 1, wherein
the predefined proximity range corresponds to a distance less than a threshold range, such that the alarm module is configured to activate the alarm when the transmitter module is detected to be closer to the receiver module than the threshold range.

5. The system of claim 1, wherein
the proximity of the transmitter module to the receiver module is determined based on a measurement of optical energy emitted by the transmitter module and received by the receiver module.

6. The system of claim 2, wherein
the pulse generator comprises a comparator circuit configured with both positive feedback and negative feedback.

7. The system of claim 6, wherein
the positive feedback of the comparator circuit includes a resistor coupled at the comparator's inverting terminal to a resistive voltage divider connected between a battery and ground.

8. The system of claim 6, wherein
the negative feedback of the comparator circuit includes two parallel paths, a first path comprising a resistor, and a second path comprising a series combination of a diode and a resistor, both paths coupled at the comparator's inverting terminal to a capacitor connected to ground.

9. The system of claim 1, wherein
at least one of the transmitter module and the receiver module is attached to or integrated into a pet collar.

10. The system of claim 1, wherein
at least one of the transmitter module and the receiver module is integrated into a wearable accessory selected from the group consisting of a remote control, wristband, necklace, watch, belt, ring, and pendant.

11. The system of claim 2, wherein
the pulse detector comprises a comparator operatively coupled to a multivibrator circuit.

12. The system of claim 1, wherein
the transmitter module and the receiver module are integrated into a common housing or accessory, and the system is configured to detect proximity based on light pulses emitted by the transmitter module that are reflected off an external object and received by the receiver module.

13. The system of claim 12, wherein
the common housing or accessory is worn by a first pet; and
the external object is a passive reflective surface integrated into a second pet collar, accessory, or wearable item.

14. The system of claim 1, wherein
the transmitter module is configured to emit at least a first-type light pulse having a first characteristic and a second-type light pulse having a second characteristic; and
the receiver module is configured to detect and distinguish between the first-type light pulse and the second-type light pulse.

15. The system of claim 14, wherein
the first characteristic and the second characteristic correspond to different optical wavelengths.

16. The system of claim 14, wherein
the first characteristic and the second characteristic correspond to different pulse widths, pulse repetition rates, or duty cycles.

17. The system of claim 1, wherein
the alarm comprises at least one of a visual indicator, audible indicator, vibration motor, or electrical stimulus device.

18. A pet proximity detection system comprising:
a transmitter module configured to emit light pulses, wherein
the transmitter module comprises a pulse generator configured to generate electrical pulses and an optical emitter configured to emit the light pulses in response to the electrical pulses;
a receiver module configured to detect the light pulses and determine whether the transmitter module is within a predefined proximity range, wherein
the receiver module comprises a photodetector configured to detect the light pulses and a pulse detector configured to process signals from the photodetector to determine a proximity between the transmitter module and the receiver module; and
an alarm module operatively coupled to the receiver module and configured to activate an alarm in response to a determination that the transmitter module is within the predefined proximity range;
wherein
at least one of the transmitter module and the receiver module is attached to or integrated into a pet collar.

19. The system of claim 18, wherein
the transmitter module and the receiver module are integrated into the pet collar, and the system is configured to detect proximity based on light pulses emitted by the transmitter module that are reflected off an external object and received by the receiver module;
wherein
the external object is a passive reflective surface integrated into a second pet collar, accessory, or wearable item.

20. The system of claim 18, wherein
the transmitter module is configured to emit at least a first-type light pulse having a first characteristic and a second-type light pulse having a second characteristic; and
the receiver module is configured to detect and distinguish between the first-type light pulse and the second-type light pulse.
